(19) United States
(12) Patent Application Publication
(10) Pub. No.: US 2024/0134803 A1
(43) Pub. Date: Apr. 25, 2024

(54) HARDWARE ASSISTED MEMORY ACCESS TRACKING

(71) Applicant: Intel Corporation, Santa Clara, CA (US)

(72) Inventors: Sanjay Kumar, Hillsboro, OR (US); Phillip Lantz, Cornelius, OR (US); Rajesh Sankaran, Portland, OR (US); David Hansen, Portland, OR (US); Evgeny V. Voevodin, Portland, OR (US); Andrew Anderson, Forest Grove, OR (US); Lizhen You, Beijing (CN); Xin Zhou, Beijing (CN); Nikhil Talpallikar, Portland, OR (US)

(73) Assignee: Intel Corporation, Santa Clara, CA (US)

(21) Appl. No.: 18/279,029

(22) PCT Filed: Mar. 24, 2021
(86) PCT No.: PCT/CN2021/082935

§ 371 Date: Aug. 24, 2023

(51) Int. Cl. G06F 12/1009

(52) U.S. Cl. CPC G06F 12/1009

(57) ABSTRACT

An embodiment of an integrated circuit may comprise an array of hardware counters, and circuitry communicatively coupled to the array of hardware counters, the circuitry to count accesses to one or more selected pages of a memory with the array of hardware counters. Other embodiments are disclosed and claimed.

### BACKGROUND

### 1. Technical Field

This disclosure generally relates to memory technology, and tiered memory technology.

### 2. Background Art

Tiered memory systems include heterogeneous memory where a first memory tier generally has lower latency with lower capacity and a second memory tier generally has higher capacity with higher latency. Migration technology includes a wide variety of techniques utilized to efficiently move data between the first and second memory tiers. In some systems, the first memory tier may be referred to as near memory and the second memory tier may be referred to as far memory.

Some graphics processor units (GPUs) include an access counter feature that keep track of the frequency of access that a GPU makes to memory located on other processors. The access counters are described as helping to ensure memory pages are moved to the physical memory of the processor that is accessing the pages most frequently.

### BRIEF DESCRIPTION OF THE DRAWINGS

The various embodiments of the present invention are illustrated by way of example, and not by way of limitation, in the figures of the accompanying drawings and in which:

FIG. 1 is a block diagram of an example of an integrated circuit according to an embodiment;

FIGS. 2A to 2B are flow diagrams of an example of a method according to an embodiment;

FIG. 3 is a block diagram of an example of an apparatus according to an embodiment;

FIG. 4 is a block diagram of an example of a computing system according to an embodiment;

FIG. 5 is a block diagram of an example of a memory access tracker (MAT) device according to an embodiment;

FIG. 6 is a block diagram of another example of a computing system according to an embodiment;

FIG. 7 is an illustrative diagram of an example of a strided page count array (PCA) according to an embodiment;

FIG. 8A is a block diagram illustrating both an exemplary in-order pipeline and an exemplary register renaming, out-of-order issue/execution pipeline according to embodiments of the invention.

FIG. 8B is a block diagram illustrating both an exemplary embodiment of an in-order architecture core and an exemplary register renaming, out-of-order issue/execution architecture core to be included in a processor according to embodiments of the invention;

FIGS. 9A-B illustrate a block diagram of a more specific exemplary in-order core architecture, which core would be one of several logic blocks (including other cores of the same type and/or different types) in a chip;

FIG. 10 is a block diagram of a processor that may have more than one core, may have an integrated memory controller, and may have integrated graphics according to embodiments of the invention;

FIGS. 11-14 are block diagrams of exemplary computer architectures; and

FIG. 15 is a block diagram contrasting the use of a software instruction converter to convert binary instructions in a source instruction set to binary instructions in a target instruction set according to embodiments of the invention.

### DETAILED DESCRIPTION

Embodiments discussed herein variously provide techniques and mechanisms for hardware assisted memory access tracking. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide hardware assisted memory access tracking.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

An operating system may determine hot and cold pages by counting CPU accesses to the pages. The OS may utilize any of a number of techniques to track software access to memory pages. For example, the OS may track page tables accessed and dirty bits (A/D bits) from a page table and/or an extended page table. The OS today can scan and clear the page tables A/D bits periodically or on memory pressure to decide which pages are cold or hot pages. A problem with this technique is that clearing the A/D bit requires the software to walk the page table and the CPU to set it again on next access, which may be costly in terms of both CPU cycles and input/output (TO). A/D bit clearing may also require a translation lookaside buffer (TLB) shootdown for accuracy, which is also costly.

For other software based access counting, the OS tracks accesses to physical pages which occur outside normal application page table mappings (e.g., access via OS page tables, IOMMU, direct memory access (DMA), etc.). A problem with this technique is that this approach can only track accesses to application pages which directly involve system software in the access. Many accesses are performed via application page tables and do not involve system software after setup of the page table.

The OS may also utilize CPU page faults to track memory accesses by periodically setting page table entries (PTEs) to not present. The physical memory remains allocated and resident in memory. On a page fault, the page being accessed and the initiator accessing it are recorded and the page is made present in the PTE. A problem with this technique is that page faults are costly and hence taking page faults to count memory accesses is costly. The page fault is processed by the same workload thread and hence the page fault processing interferes with workload execution.

Some embodiments overcome one or more of the foregoing problems by providing hardware counting technology that is located in the memory access path from the CPU to memory (e.g., including various memory tiers as described in further detail below). For example, embodiments of the hardware counting technology may assist a CPU's memory access counting and/or hot/cold page notifications. Some embodiments of the technology may include an array of hardware counters (e.g., organized as a set-associative array) that count accesses to various pages. Advantageously, some embodiments help software determine access rate of pages within software defined epochs at a much lower cost in terms of CPU cycles and/or TO. If a counter value of one of the hardware counters reaches a software defined threshold, the page address and its counter value are reported to software.

Another advantage is that some embodiments of the hardware counting technology offloads the page access counting from software which significantly reduces software overhead. Moreover, the hardware counting may be more accurate and the software may be better able to determine hot and cold pages and perform more effective page migrations between different memory tiers to optimize application performance. For example, software doesn't need to scan/clear page table A/D bits or induce page-faults to count accesses. Embodiments of the hardware counting technology can be configured to provide a list of hot pages to software which significantly reduces the software's overhead for determining the hot pages (e.g., for migration from one memory tier to another memory tier).

As used herein, a hardware counter refers to a self-contained circuit that is configured to perform the count operation without assistance from software (e.g., the OS) or other hardware outside the hardware counter (e.g., the CPU). For example, a suitable hardware counter may be implemented with combinatorial logic and/or discrete circuits to reset an output value of the hardware counter to an initial value (e.g., zero, or a value applied to an input signal of the hardware counter) upon assertion of a reset signal, and to increment the output value of the hardware counter by a fixed amount (e.g., one, or a configurable increment value applied to an input signal of the hardware counter) upon assertion of an increment signal.

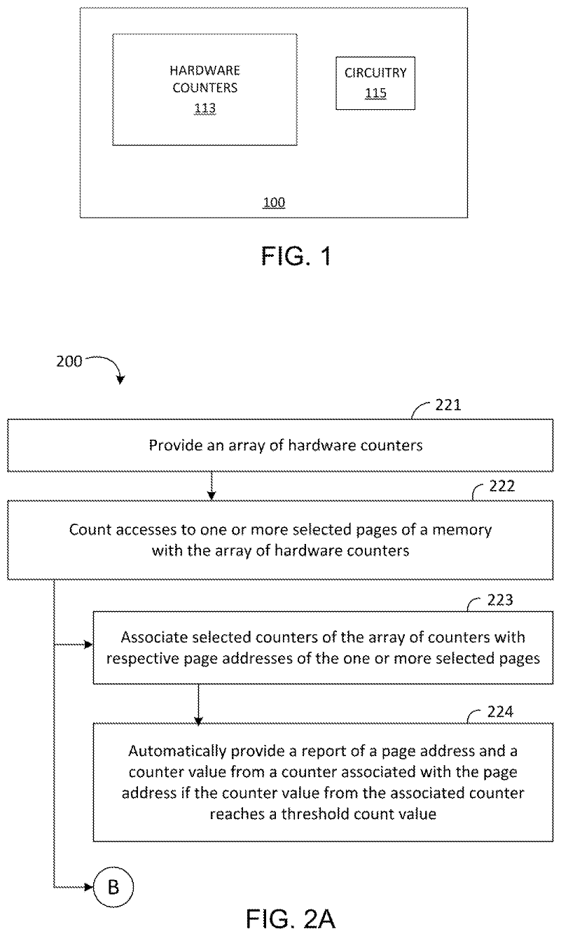

With reference to FIG. 1, an embodiment of an integrated circuit 100 may include an array of hardware counters 113, and circuitry 115 communicatively coupled to the array of hardware counters 113. The circuitry 115 may be configured to count accesses to one or more selected pages of a memory with the array of hardware counters. All or portions of the memory may be located on the integrated circuit 100 and/or may be external to the integrated circuit 100. For example, the circuitry 115 may be configured to associate selected counters of the array of hardware counters 113 with respective page addresses of the one or more selected pages. In some embodiments, the circuitry 115 may also be configured to automatically provide a report of a page address and a counter value from a counter associated with the page address if the counter value from the associated counter reaches a threshold count value.

In some embodiments, the array of hardware counters 113 may include a hardware counter set organized as a set-associate array of hardware counters, and the circuitry 115 may be further configured to manage one or more configuration registers to store one or more of selected address range information, an increment value, an upper threshold count value, and a lower threshold count value. For example, the circuitry 115 may be configured to determine if a page address of an access to the memory hits an entry in the hardware counter set, and, if so determined, increment a counter associated with the page address by the increment value stored in the one or more configuration registers, and provide a report of the page address and a counter value from the counter associated with the page address if the counter value from the associated counter exceeds a maximum threshold value (e.g., the upper threshold count value). The circuitry 115 may also be configured to determine if a page address of an access to the memory misses in the hardware counter set, and, if so determined, allocate and initialize a free counter from the hardware counter set to the page address. If no free counter is available, the circuitry 115 may also be configured to evict a page address from the set-associative array based on an eviction policy, and provide a report of the evicted page address and a counter value from a counter associated with the evicted page address if the counter value from the associated counter exceeds a minimum threshold count value (e.g., the lower threshold count value).

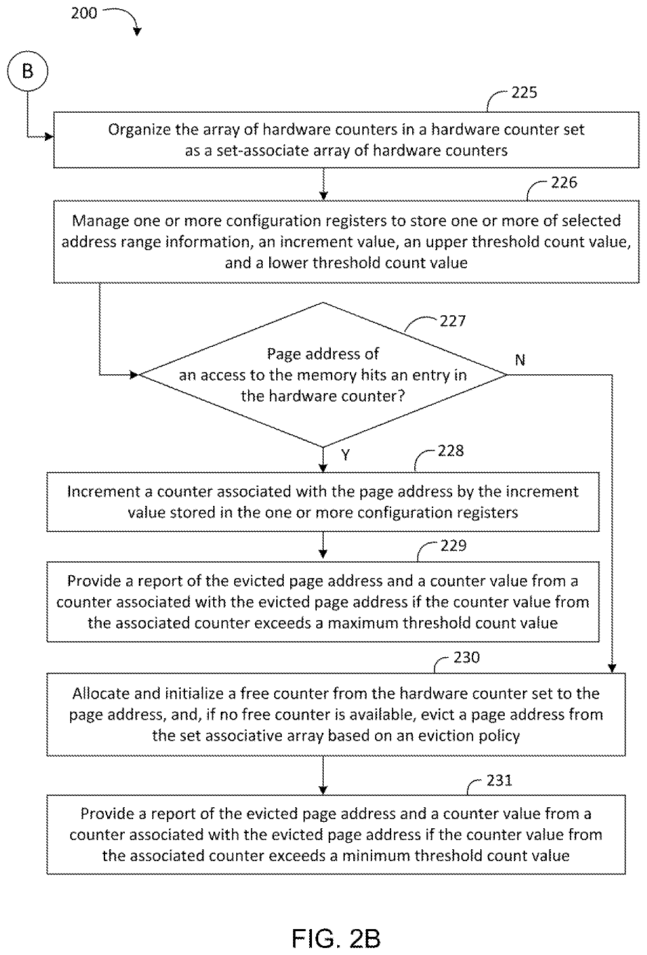

With reference to FIGS. 2A to 2B, an embodiment of a method 200 may include providing an array of hardware counters at box 221, and counting accesses to one or more selected pages of a memory with the array of hardware counters at box 222. For example, the method 200 may include associating selected counters of the array of hardware counters with respective page addresses of the one or more selected pages at box 223. The method 200 may also include automatically providing a report of a page address and a counter value from a counter associated with the page address if the counter value from the associated counter reaches a threshold count value at box 224.

Some embodiments of the method 200 may further include organizing the array of hardware counters in a hardware counter set as a set-associate array of hardware counters at box 225, and managing one or more configuration registers to store one or more of selected address range information, an increment value, an upper threshold count value, and a lower threshold count value at box 226. For example, the method 200 may include determining if a page address of an access to the memory hits an entry in the hardware counter set at box 227 and, if so determined, incrementing a counter associated with the page address by the increment value stored in the one or more configuration registers at box 228, and providing a report of the evicted page address and a counter value from a counter associated with the evicted page address if the counter value from the associated counter exceeds a maximum threshold count value at box 229. The method 200 may also include determining if a page address of an access to the memory misses in the hardware counter set at box 227 (e.g., does not hit an entry in the hardware counter set) and, if so determined, the method 200 may also include allocating and initializing a free counter from the hardware counter set to the page address, and, if no free counter is available, evicting a page address from the set-associative array based on an eviction policy at box 230, and providing a report of the evicted page address and a counter value from a counter associated with the evicted page address if the counter value from the associated counter exceeds a minimum threshold count value at box 231.

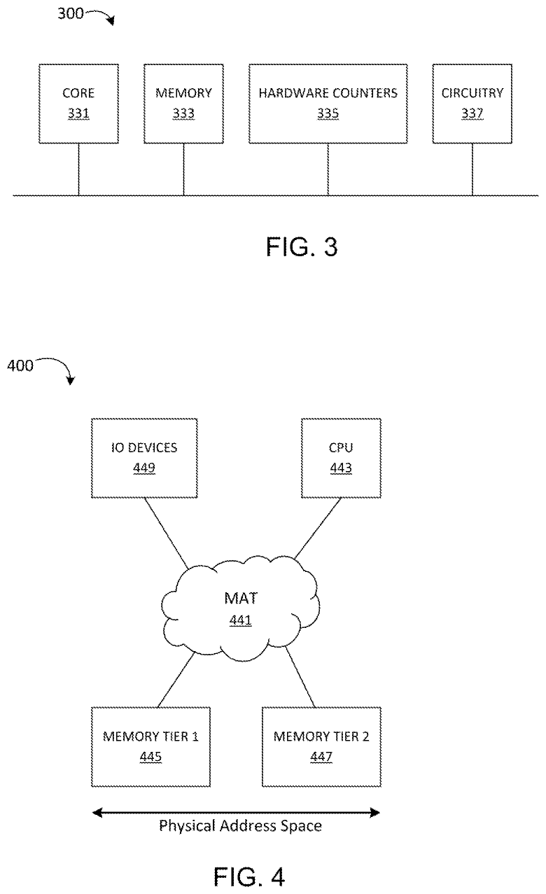

With reference to FIG. 3, an embodiment of an apparatus 300 may include a core 331, memory 333 communicatively coupled to the core 331, an array of hardware counters 335, and circuitry 337 communicatively coupled to the core 331, the memory 333, and the array of hardware counters 335. The circuitry 337 may be configured to count accesses to one or more selected pages of the memory 333 with the array of hardware counters 335. For example, the circuitry 337 may be configured to associate selected counters of the array of hardware counters 335 with respective page addresses of the one or more selected pages. In some embodiments, the circuitry 337 may also be configured to automatically provide a report of a page address and a counter value from a counter associated with the page address if the counter value from the associated counter reaches a threshold count value.

In some embodiments, the array of hardware counters 335 may include a hardware counter set organized as a set-associate array of hardware counters, and the circuitry 337 may be configured to manage one or more configuration registers to store one or more of selected address range information, an increment value, an upper threshold count value, and a lower threshold count value. For example, the circuitry 337 may be configured to determine if a page address of an access to the memory 333 hits an entry in the hardware counter set and, if so determined, increment a counter associated with the page address by the increment value stored in the one or more configuration registers. The circuitry 337 may also be configured to determine if a page address of an access to the memory misses in the hardware counter set, and, if so determined, allocate and initialize a free counter from the hardware counter set to the page address. If no free counter available, the method 200 may also be configured to evict a page address from the set-associative array based on an eviction policy, and provide a report of the evicted page address and a counter value from a counter associated with the evicted page address if the counter value from the associated counter exceeds a minimum threshold count value.

Some embodiments may provide hardware support for hot and cold page tracking in the OS for tiered memory management. A computer system may have heterogeneous memory (e.g., or tiered memory) with varying performance characteristics. For example, besides dynamic random access memory (DRAM), a system may also have high bandwidth memory (HBM), persistent memory (e.g., INTEL OPTANE, etc.) on server and client systems. Systems may also have accelerators with local memory (e.g., HBM on GPUs) or remote pooled memory attached via a coherent link such as Compute Express Link (CXL). These memory regions may be exposed to the OS at different physical address ranges typically in separate non-uniform memory access (NUMA) nodes. A processor may have cacheable (e.g., write-back) access to all the different memory regions. Memory accesses may be performed by many different entities in a system. The CPU is the most typical memory access initiator, but many kinds of devices may also act as initiators. As used herein, the term nearer memory (NM) refers to memory that provides best latency/bandwidth to initiator accesses and the term farther memory (FM) refers to lower performance memory for the initiator access relative to NM.

An OS and/or a virtual machine monitor (VMM) may manage the tiered memory to optimize overall performance of the system. The general goal is to place frequently accessed (hot) data in NM and infrequently accessed or un-accessed (cold) data in FM. Some embodiments provide hardware support to enhancing memory placement and migration decisions by the OS/VMM to provide workloads an improved or optimal price/performance from all the tiered memory in the system. For example, embodiments of hardware counting technology may help the OS/VMM efficiently detect hot pages in FM and migrate them to NM and may also help the OS/VMM efficiently detect cold pages in NM and migrate them to FM.

With reference to FIG. 4, an embodiment of a computing system 400 includes hardware counting technology configured as a memory access tracker (MAT) device 441 that is located in a memory access path between a CPU 443, a first memory tier 445, a second memory tier 447, and 10 devices 449. The MAT device 441 is depicted with indistinct borders because portions of the hardware associated with the device 441 may be distributed throughout the system 400. The MAT device 441 is configured to observe and count memory accesses to various physical memory ranges and to report the addresses and their counts to software. The device 441 counts memory accesses at a page granularity where a page size is configurable and may be different than a page size for pages in CPU page tables. The MAT device 441 may be inline with the memory access path or may be out of the direct memory access path with suitable connections to snoop the page address information for the memory accesses.

The actual location of hardware associated with the MAT device 441 includes any suitable place in the memory access path. For example, the device 441 may be implemented inside a core of the CPU 443, outside the core in a Last Level Cache (LLC)/Caching Home Agent (CHA), at a memory controller, inside a memory device (e.g., in a CXL device), or as a separate device on the coherent fabric. In some embodiments, there may be more than one MAT device 441 in the system 400 (e.g., one MAT device 441 per memory tier).

In some embodiments, the MAT device 441 is implemented outside the CPU 443 core and counts and notifies physical addresses to software. The MAT device 441 counts memory accesses to the physical address range of interest using a set of page-granular counters and reports those counts to software using a Notification Queue (NFQ) and a Page Counter Array (PCA), as described in more detail below.

In some embodiments, the MAT device 441 may be implemented inside the CPU 443 core and may count and notify virtual addresses to software. When implemented inside the CPU 443 core, the MAT device 441 may notify counts to software in-band using the application CPU cycles.

In some embodiments, the MAT device 441 counts both CPU and 10 accesses to memory. In some embodiments, the MAT device 441 may count only CPU accesses to memory (e.g., because 10 accesses are typically pinned and not migratable). In some embodiments, the MAT device 441 may avoid counting streaming accesses (e.g., using CPU non-temporal streaming instructions).

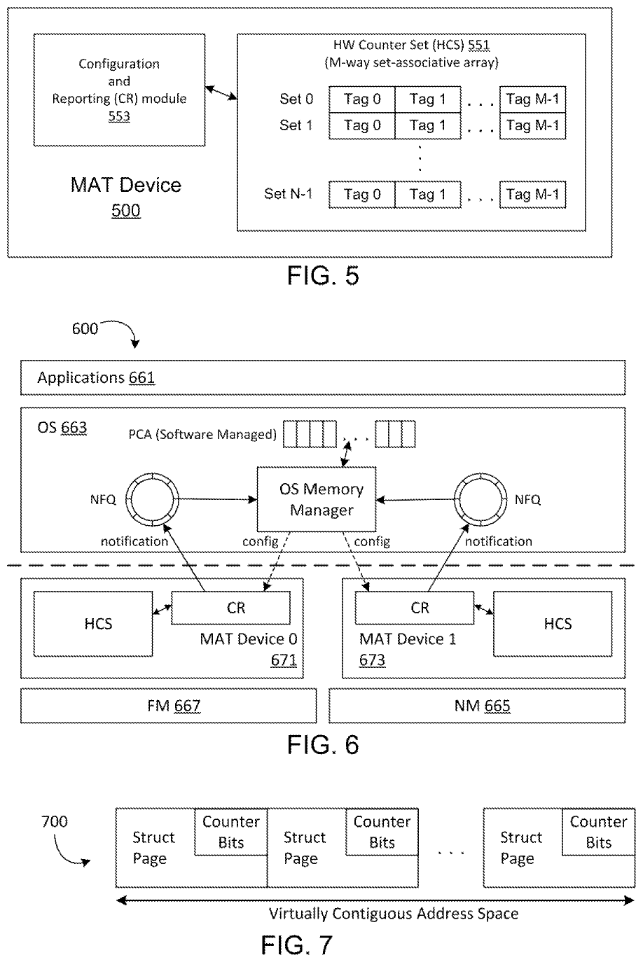

With reference to FIG. 5, an embodiment of a MAT device 500 includes components that counts memory accesses and components that interact with software. The counting components includes a set of counters referred to as a hardware counter set (HCS) 551 organized as an N-sets by M-ways set-associative array, where N and M are both greater than one (1). The components that interact with software includes a configuration and reporting (CR) module 553. The CR module 553 includes configuration registers (e.g., memory mapped IO (MMIO) registers). In some embodiments, the counting components and software visible components may be physically co-located. Alternatively, in other embodiments, the counting components may be physically at a different location than the software interface components.

With reference to FIG. 6, an embodiment of a computing system 600 includes applications 661 that run on an OS 663. The system 600 includes tiered memory with a NM 665 and a FM 667, and two MAT devices 671 and 673 (with MAT Device 0 for FM and MAT Device 1 for NM). Each MAT device 671 and 673 has its own CR module and HCS. The components above the dashed line are software components while the components below the dashed line are hardware components.

The MAT devices 671, 673 may utilize different methods to notify page access counts to software, including a notification queue (NFQ) and a page counter array (PCA). The NFQ may be utilized to communicate frequent pages accesses to software, that need relatively immediate action. The NFQ efficiently addresses the problem of identifying the hottest pages. The PCA may be utilized to communicate less-frequent pages accesses to software, that can tolerate a longer delay before action. The PCA efficiently addresses the problem of identifying how many times an individual page has been accessed. In some embodiments, the PCA is updated directly by the MAT device(s) (e.g., a hardware (HW) managed PCA). Alternatively, in some embodiments, the PCA is updated by software by reading page addresses and counts from the NFQ (e.g., a software managed PCA).

In some embodiments, software specifies which memory regions should be counted through a set of memory range registers in the respective CR modules of the MAT devices 671, 673. The memory range registers may also specify reporting of counters to software through the NFQ or PCA. When one of the MAT devices 671, 673 needs to notify a page and its count to software (e.g., when the count reaches an upper threshold), the MAT device 671, 673 notifies the software through the NFQ, PCA, or both as per the configuration stored in the registers.

HCS Examples

An embodiment of a MAT device includes a HCS for counting accesses to pages. If an address hits into the set-associative array of the HCS, the value of the counter associated with the address is incremented by a software specified value. If the counter value reaches a configured threshold value (e.g., as described below), the count and page address is reported to software.

In some embodiments, a MAT device supports two thresholds for reporting page addresses to software. Software can configure these thresholds based on the software's hot/cold page tracking heuristics. In some embodiments, the two thresholds are global thresholds that apply to all counters in the MAT device. The two thresholds may correspond to a maximum (MAX) threshold value and a minimum (MIN) threshold value. When a counter's count reaches the MAX threshold, the MAT device may consider the page as hot and the corresponding address gets notified to software. When a counter is being evicted from the set-associative array and its value is greater than or equal to the MIN threshold, the corresponding page address is notified to software. The MIN threshold value is generally, but not always, set lower than the MAX threshold value.

Examples of a HCS with a Limited Number of Counters

In some embodiments, a MAT device may implement a limited number of counters (e.g., on the order of a few thousands to a few tens of thousands, but less than a total number of pages) in a HCS which are allocated to currently accessed addresses similar to a cache (e.g., in a set-associative array) (e.g., as shown in FIG. 5). These counters may either be embedded in a CPU or a memory side cache structure, or the counters may be independent structure.

In some embodiments, the counters are automatically allocated to incoming accessed page addresses. Incoming new page addresses may also cause eviction of other addresses from counters (e.g., to make room for the new addresses) based on any suitable eviction policy such as least recently used (LRU). The evicted page and its count may optionally be notified to software. If a page hits into the HCS, its counter value is incremented.

A limited number of hardware counters may not be sufficient to effectively count all the pages (e.g., there may be billions of pages). In some embodiments, to count more pages than can be counted by the limited number of hardware counters, a MAT device may divide counting responsibility between hardware and software. Because hardware provides a limited number of counters, software allocates an array of counters in memory (e.g., one for every page) to count page accesses (e.g., the PCA).

Hardware counts the addresses that hit into the HCS. When an address is evicted from HCS, the evicted address and corresponding count is reported to software (e.g., the address may be evicted based on the MIN threshold value). Software can then add the evicted counts into the corresponding counters in the PCA. After the addition, if the PCA counter reaches above the MAX threshold, software can consider the page as hot. The MIN threshold gives more control to software in receiving address notifications when working with limited number of hardware counters. For example, if the software didn't want to lose any counts for any pages due to evictions, software may set the MIN Threshold to 1. Alternatively, software may set the MIN threshold greater than or equal to the MAX threshold if software doesn't want to receive any eviction notifications.

More counters in hardware will generally lead to higher hit rate in the HCS and hence less evictions. Less evictions reduces or avoids CPU overhead of eviction processing by software. Irrespective of the number of hardware counters, embodiments of a MAT device can still help software detect hot/cold pages better than conventional software-only techniques (albeit with more software overheads when using less hardware counters). Embodiments of a hardware/software co-design allows greater flexibility in implementing hardware counters and allows software to work with limited number of counters.

In some embodiments, the hardware counters may count read and write accesses differently. In some embodiments, the counters can be configured to increment the count differently for read and write accesses (e.g., giving different weights to read vs write) to the page. In some embodiments, the access counters may implement separate counters for number of read and write accesses. Having separate read/write access counters allows software to account for such memories whose read and write costs are different (e.g., INTEL OPTANE technology, etc.).

In some embodiments, the access counters can also identify and report an identifier (ID) associated with the page access (e.g., a CPU ID, an IO ID, etc.). The accessor ID information may help the OS to migrate the page closer to the device that accessed the page (e.g., a CPU socket, an IO device, etc.). In some embodiments, if multiple CPUs accessed the page before it was notified to software, the counter records the ID of the last CPU that accessed the page and reports that ID to software.

In some embodiments, a MAT device may also count memory accesses at different page sizes which may be different than the page size in the page tables. In general, a minimum (e.g., and default) page size is 4 kilobytes (KB). The MAT device may be configured to track addresses at 4 KB, 8 KB, 16 KB, 32 KB, . . . , 2 megabytes (MB), 4 MB, etc. The page size for the MAT device represents the memory size that each counter is counting. The advantages of using a larger MAT page size include reducing the number of counters needed to count memory accesses, and reducing the number of hot page notifications sent to the OS.

In some embodiments, a MAT device may be configured by software to do sampled counting, where the MAT device may not count every access. For example, if a sampling rate is set to ten percent (10%), the MAT device will count every tenth (10^{th}) access. Sampled counting may be utilized to reduce counting and processing overheads.

Examples of Aging the Counters

To detect hot or cold pages, the counts should represent recent accesses. In some embodiments, for the counts to represent recent accesses, a MAT device may define a certain time interval as an epoch such that the counters are aged after every epoch. For example, counter aging may be done by resetting the counters to 0 or by reducing the counter value using some other function. In some embodiments, PCA counter aging may be done either by software or by the MAT device hardware itself.

PCA Examples

In some embodiments, the PCA is maintained in system memory and includes a counter value for every page. The PCA can be software managed or hardware managed. If a software managed PCA is enabled, the software reads the notifications from NFQ (e.g., due to MAX and MIN thresholds) and adds them to the corresponding counter in PCA. The counters in PCA are aged after every epoch.

If a hardware managed PCA is enabled, the hardware counters are treated as a cache of counters in the PCA, such that when a new page address is allocated in the HCS, an initial counter value is loaded into the counter in the HCS associated with the new page address from the corresponding location in the PCA. When a counter associated with a page address reaches the MAX threshold, the counter value is written back into the corresponding location in the PCA. When a page address is evicted from the HCS and its associated count reaches an eviction threshold (e.g., the MIN threshold), its associated count is written back into the corresponding location in the PCA. If the page is evicted from the HCS but its access count has not reached the eviction threshold, the page is evicted from HCS without updating the PCA (e.g., the access count will be lost). A hardware managed PCA can significantly reduce software overhead of maintaining the PCA. The counter values in the PCA may be contiguously located, or they may be located a fixed distance from each other using a stride.

In some embodiments of a hardware managed PCA, the counter value size is 1 byte, but other embodiments of a MAT device can support other counter value sizes as well. Software allocates the memory for the PCA that is big enough for all pages monitored by the MAT device. Software then configures the first counter value's location (e.g., Counter_Base), Counter_Size, and Stride_Shift values into the MAT device (e.g., stores the values in configuration registers). The actual counter location is determined by hardware as follows: Counter_Location=Counter_Base+(PFN<<Stride_Shift), where PFN is the page frame number of the page. After writing the counter value in the PCA, the MAT device will reset the HCS counter to zero (0) or allocate the counter to a new page, to avoid multiple back-to-back counter updates for the same address.

Examples of Usage of the PCA by Software

The PCA can be used to provide an OS with access to page access counts. The OS can periodically scan the PCA to get the page access count of all the pages. Additionally, given a page, the OS can easily find out its access count by reading the corresponding counter. Embodiments of a MAT device supports commands to enable the OS to flush the MAT device's counter cache to the PCA to ensure the OS gets the up-to-date access counts during a scan. The OS may reset the counters in the PCA after scanning the PCA to get fresh counts for the next scan. In some embodiments, at the time of updating the PCA counter values, the MAT device performs a read-modify-write operation to write the cumulative value to the PCA counter values.

With reference to FIG. 7, an embodiment of a strided PCA 700 includes an array of per-page meta-data structures that each include counter value bits on a regular stride. An OS/VMM may maintain one or more ordered lists of pages that are ordered based on accesses made to them (e.g., a LRU list in LINUX). This ordered list helps the OS to determine cold pages which can be evicted from higher performance tier memory to lower performance tier memory. An OS may also maintain a per-page meta-data structure (e.g., struct page in LINUX) which contains the LRU list information and page access information. These meta-data structures are virtually contiguous and generally 64 bytes in size. The OS can carve out one or two bytes of the 64 bytes as the counter value of the PCA for that page, advantageously embedding the PCA within an existing OS management structure. The counter value in per-page meta-data can be used by the OS to quickly obtain access counts for pages and significantly reduce the overhead of scanning and maintaining an ordered (e.g., LRU) page list.

NFQ Examples

To help the OS efficiently determine hot pages, some embodiments of a MAT device reports pages and their counts to software using a memory based circular notification queue (NFQ). For example, software may configure the base, size, head, and tail of the queue before enabling the MAT device. The MAT device then enqueues the notifications at a tail index and increments the tail. If the NFQ is full, new notifications are dropped. Software consumes the notifications from the head index.

When the MAT device needs to notify a hot page to software (e.g., when either a page access count reaches the MAX threshold, or the page address is being evicted from the hardware counter set and the access count associated with the evicted page address has reached the MIN threshold), the MAT device prepares a notification descriptor (e.g., containing the page address and its associated count) and writes the notification descriptor into the NFQ. In some embodiments, both MAX and MIN threshold notifications are written to a single NFQ. Alternatively, in some embodiments, a MAT device may use two different NFQs, one for MAX threshold notifications and another for MIN Threshold (e.g., eviction) notifications.

In some embodiments, a MAT device may support generating an in-band interrupt (e.g., a Message Signaled Interrupt (MSI)) when a hot page notification is added to the NFQ. The MAT device may also support an interrupt threshold to control batching of interrupts. When inserting a descriptor into the NFQ, for example, if the number of notification descriptors in the queue reaches the interrupt threshold, an interrupt is generated by the MAT device. Otherwise the interrupt generation is skipped. The interrupt threshold helps reduce the number of interrupts to the software.

After writing the notification descriptor into the NFQ, in some embodiments, the MAT device will reset the HCS counter to zero (0), allocate the counter to a new page address, or mark the counter as free to be allocated to the next new page address (e.g., to avoid multiple back-to-back hot-page notifications for the same page address).

Advantageously, an OS/VMM can efficiently determine the list of hot pages by reading the NFQ. The OS/VMM may process the NFQ on demand, after receiving an interrupt, etc. For example, an interrupt handler may start a kernel thread that reads head and tail registers associated with the NFQ and processes descriptors starting from the head and continuing through the tail index. As part of the descriptor processing, for example, the OS may migrate a hot page from a FM tier to a NM tier.

After processing all descriptors between the head and tail, the interrupt handler updates the head register to be equal to the tail value. However, because the MAT device may not generate an interrupt on every descriptor addition to the NFQ, the interrupt handler thread may read the tail register again to check if more notifications were added by MAT during the processing of previous notifications. If more descriptors are present, the interrupt handler may process the new batch of descriptors before returning. For example, the interrupt handler may return only when the NFQ is empty.

Advantageously, embodiments of a multi-tier memory system that utilizes one or more MAT devices may detect hot-pages much faster and may approach DRAM-only throughput much faster than conventional memory management technology (e.g., which may be choppy because of periodic page-fault handling by the workload thread). For some workloads, embodiments of a MAT device can help a multi-tier memory system achieve higher throughput with fewer migrations (e.g., by detecting higher quality hot pages as compared to conventional migration technology).

Those skilled in the art will appreciate that a wide variety of devices may benefit from the foregoing embodiments. The following exemplary core architectures, processors, and computer architectures are non-limiting examples of devices that may beneficially incorporate embodiments of the technology described herein.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

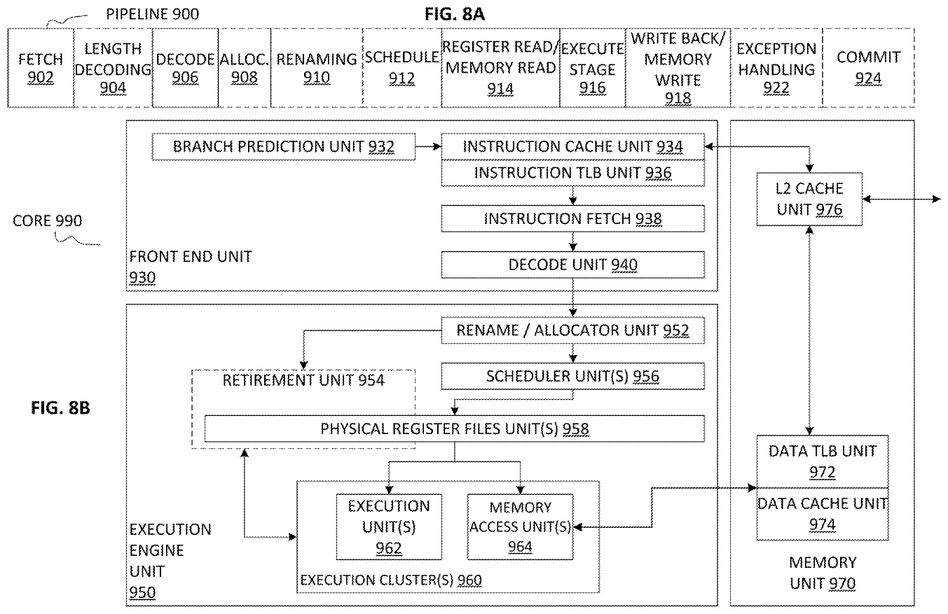

FIG. 8A is a block diagram illustrating both an exemplary in-order pipeline and an exemplary register renaming, out-of-order issue/execution pipeline according to embodiments of the invention. FIG. 8B is a block diagram illustrating both an exemplary embodiment of an in-order architecture core and an exemplary register renaming, out-of-order issue/execution architecture core to be included in a processor according to embodiments of the invention. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 8B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

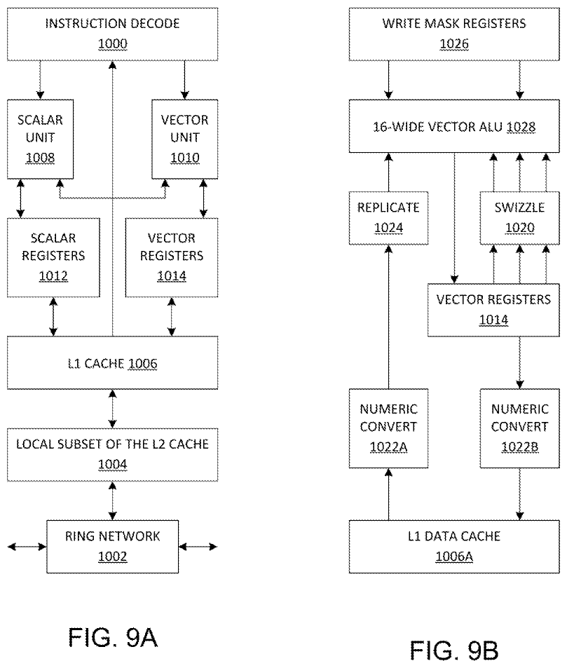

FIGS. 9A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 9A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 9B is an expanded view of part of the processor core in FIG. 9A according to embodiments of the invention. FIG. 9B includes an L1 data cache 1006A part of the L1 cache 1006, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

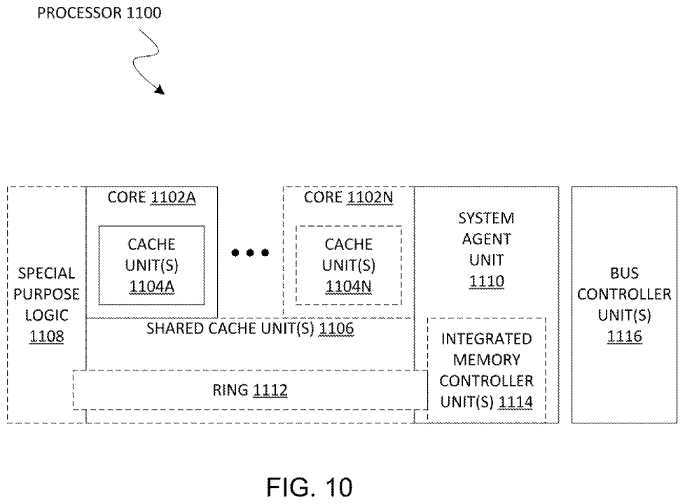

FIG. 10 is a block diagram of a processor 1100 that may have more than one core, may have an integrated memory controller, and may have integrated graphics according to embodiments of the invention. The solid lined boxes in FIG. 10 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of respective caches 1104A-N within the cores 1102A-N, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

Exemplary Computer Architectures

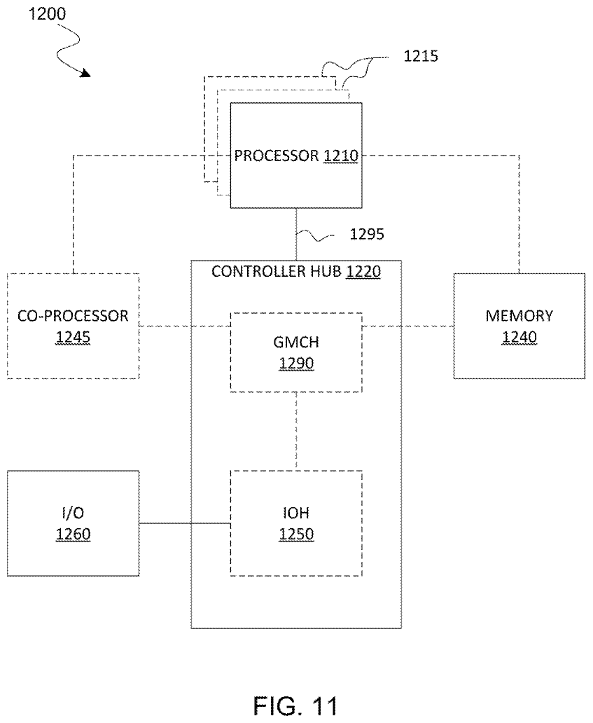

FIGS. 11-14 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 11 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

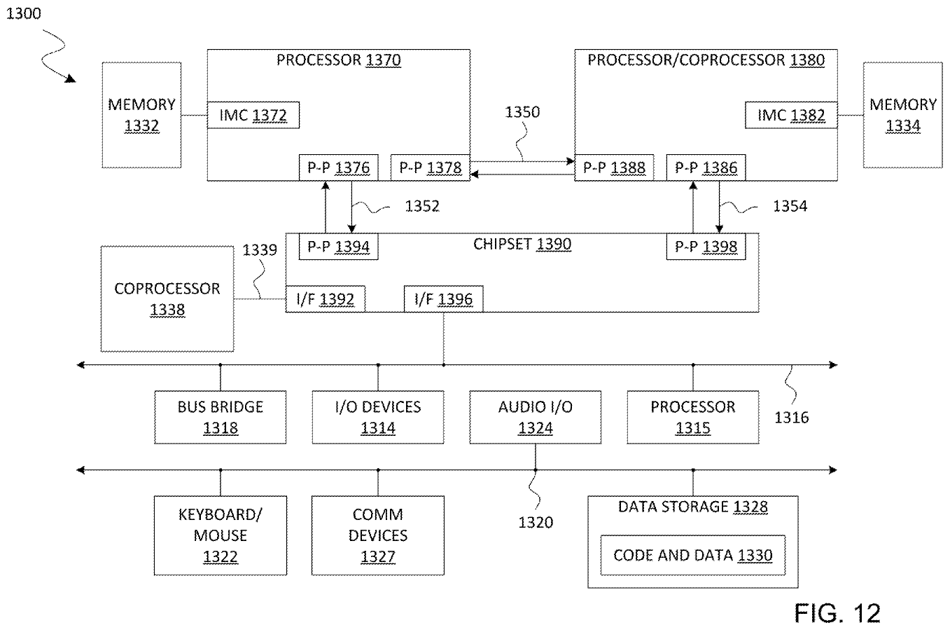

Referring now to FIG. 12, shown is a block diagram of a first more specific exemplary system 1300 in accordance with an embodiment of the present invention. As shown in FIG. 12, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 12, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339 and an interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 12, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 12, a system may implement a multi-drop bus or other such architecture.

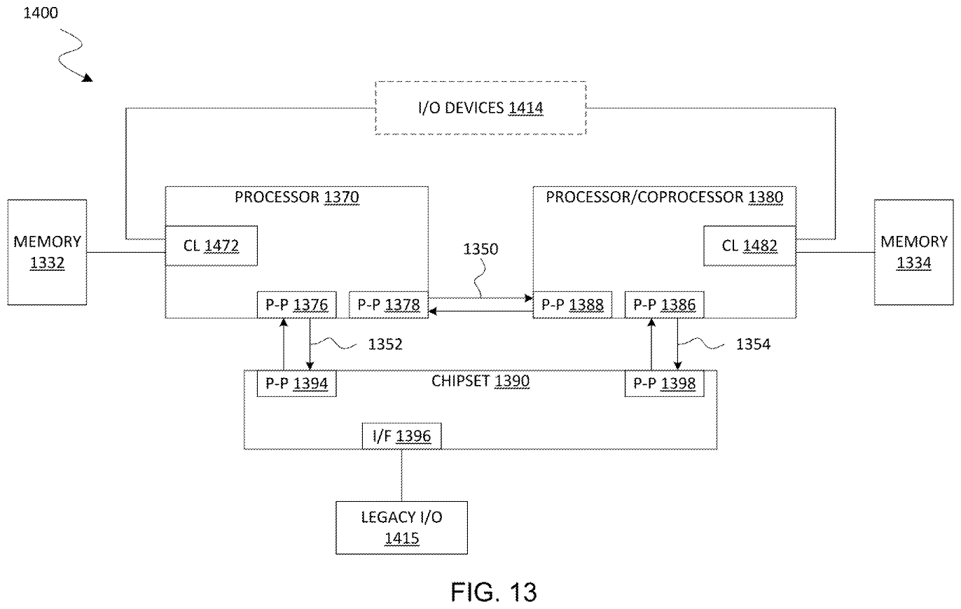

Referring now to FIG. 13, shown is a block diagram of a second more specific exemplary system 1400 in accordance with an embodiment of the present invention. Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1370, 1380 may include integrated memory and I/O control logic (“CL”) 1472 and 1482, respectively. Thus, the CL 1472, 1482 include integrated memory controller units and include I/O control logic. FIG. 13 illustrates that not only are the memories 1332, 1334 coupled to the CL 1472, 1482, but also that I/O devices 1414 are also coupled to the control logic 1472, 1482. Legacy I/O devices 1415 are coupled to the chipset 1390.

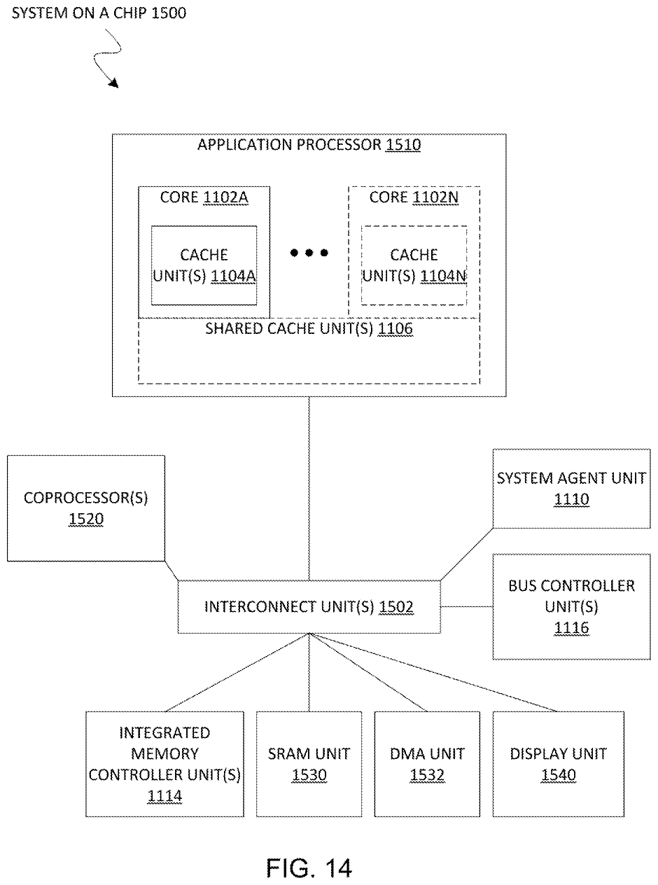

Referring now to FIG. 14, shown is a block diagram of a SoC 1500 in accordance with an embodiment of the present invention. Similar elements in FIG. 10 bear like reference numerals. Also, dashed lined boxes are optional features on more advanced SoCs. In FIG. 14, an interconnect unit(s) 1502 is coupled to: an application processor 1510 which includes a set of one or more cores 1102A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

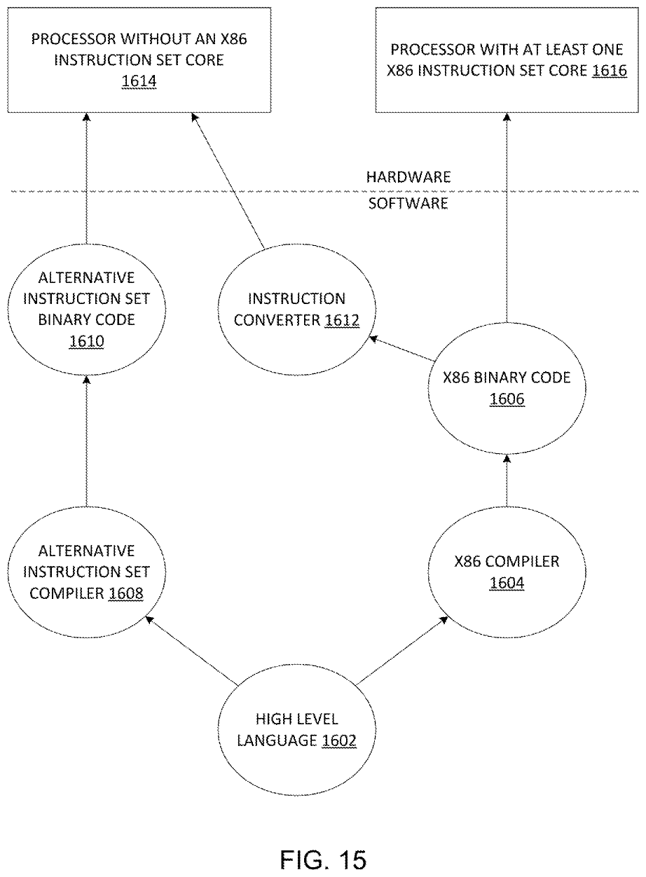

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 15 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, CA and/or that execute the ARM instruction set of ARM Holdings of Sunnyvale, CA). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

Additional Notes and Examples

Example 1 includes an integrated circuit, comprising an array of hardware counters, and circuitry communicatively coupled to the array of hardware counters, the circuitry to count accesses to one or more selected pages of a memory with the array of hardware counters.

Example 2 includes the integrated circuit of Example 1, wherein the circuitry is further to associate selected counters of the array of hardware counters with respective page addresses of the one or more selected pages.

Example 3 includes the integrated circuit of Example 2, wherein the circuitry is further to automatically provide a report of a page address and a counter value from a counter associated with the page address if the counter value from the associated counter reaches a threshold count value.

Example 4 includes the integrated circuit of any of Examples 1 to 3, wherein the array of hardware counters comprises a hardware counter set organized as a set-associate array of hardware counters.

Example 5 includes the integrated circuit of Example 4, wherein the circuitry is further to manage one or more configuration registers to store one or more of selected address range information, an increment value, an upper threshold count value, and a lower threshold count value.

Example 6 includes the integrated circuit of Example 5, wherein the circuitry is further to determine if a page address of an access to the memory hits an entry in the hardware counter set, and, if so determined, increment a counter associated with the page address by the increment value stored in the one or more configuration registers, and provide a report of the page address and a counter value from the counter associated with the page address if the counter value from the associated counter exceeds a maximum threshold value.

Example 7 includes the integrated circuit of any of Examples 5 to 6, wherein the circuitry is further to determine if a page address of an access to the memory misses in the hardware counter set; and, if so determined, allocate and initialize a free counter to the page address; and, if no free counters are available, evict a page address from the set-associative array based on an eviction policy, and provide a report of the evicted page address and a counter value from a counter associated with the evicted page address if the counter value from the associated counter exceeds a minimum threshold count value.

Example 8 includes a method, comprising providing an array of hardware counters, and counting accesses to one or more selected pages of a memory with the array of hardware counters.

Example 9 includes the method of Example 8, further comprising associating selected counters of the array of hardware counters with respective page addresses of the one or more selected pages.

Example 10 includes the method of Example 9, further comprising automatically providing a report of a page address and a counter value from a counter associated with the page address if the counter value from the associated counter reaches a threshold count value.

Example 11 includes the method of any of Examples 8 to 10, further comprising organizing the array of hardware counters in a hardware counter set as a set-associate array of hardware counters.

Example 12 includes the method of Example 11, further comprising managing one or more configuration registers to store one or more of selected address range information, an increment value, an upper threshold count value, and a lower threshold count value.

Example 13 includes the method of Example 12, further comprising determining if a page address of an access to the memory hits an entry in the hardware counter set, and, if so determined, incrementing a counter associated with the page address by the increment value stored in the one or more configuration registers, and providing a report of the page address and a counter value from the counter associated with the page address if the counter value from the associated counter exceeds a maximum threshold value.

Example 14 includes the method of any of Examples 12 to 13, further comprising determining if a page address of an access to the memory misses in the hardware counter set; and, if so determined, allocating and initializing a free counter to the page address; and, if no free counters are available, evicting a page address from the set-associative array based on an eviction policy, and providing a report of the evicted page address and a counter value from a counter associated with the evicted page address if the counter value from the associated counter exceeds a minimum threshold count value.

Example 15 includes an apparatus, comprising a core, memory communicatively coupled to the core, and an array of hardware counters, and circuitry communicatively coupled to the core, the memory, and the array of hardware counters, the circuitry to count accesses to one or more selected pages of the memory with the array of hardware counters.

Example 16 includes the apparatus of Example 15, wherein the circuitry is further to associate selected counters of the array of hardware counters with respective page addresses of the one or more selected pages.

Example 17 includes the apparatus of Example 16, wherein the circuitry is further to automatically provide a report of a page address and a counter value from a counter associated with the page address if the counter value from the associated counter reaches a threshold count value.

Example 18 includes the apparatus of any of Examples 15 to 17, wherein the array of hardware counters comprises a hardware counter set organized as a set-associate array of hardware counters.

Example 19 includes the apparatus of Example 18, wherein the circuitry is further to manage one or more configuration registers to store one or more of selected address range information, an increment value, an upper threshold count value, and a lower threshold count value.

Example 20 includes the apparatus of Example 19, wherein the circuitry is further to determine if a page address of an access to the memory hits an entry in the hardware counter set, and, if so determined, increment a counter associated with the page address by the increment value stored in the one or more configuration registers.

Example 21 includes the apparatus of any of Examples 19 to 20, wherein the circuitry is further to evict a page address from the set-associative array based on an eviction policy, and provide a report of the evicted page address and a counter value from a counter associated with the evicted page address if the counter value from the associated counter exceeds a minimum threshold count value.

Example 22 includes an apparatus, comprising means for providing an array of hardware counters, and means for counting accesses to one or more selected pages of a memory with the array of hardware counters.

Example 23 includes the apparatus of Example 22, further comprising means for associating selected counters of the array of hardware counters with respective page addresses of the one or more selected pages.

Example 24 includes the apparatus of Example 23, further comprising means for automatically providing a report of a page address and a counter value from a counter associated with the page address if the counter value from the associated counter reaches a threshold count value.

Example 25 includes the apparatus of any of Examples 22 to 24, further comprising means for organizing the array of hardware counters in a hardware counter set as a set-associate array of hardware counters.

Example 26 includes the apparatus of Example 25, further comprising means for managing one or more configuration registers to store one or more of selected address range information, an increment value, an upper threshold count value, and a lower threshold count value.

Example 27 includes the apparatus of Example 26, further comprising means for determining if a page address of an access to the memory hits an entry in the hardware counter set, and, if so determined, means for incrementing a counter associated with the page address by the increment value stored in the one or more configuration registers, and means for providing a report of the page address and a counter value from the counter associated with the page address if the counter value from the associated counter exceeds a maximum threshold value.

Example 28 includes the apparatus of any of Examples 26 to 27, further comprising determining if a page address of an access to the memory misses in the hardware counter set; and, if so determined, means for allocating and initializing a free counter to the page address; and, if no free counters are available, means for evicting a page address from the set-associative array based on an eviction policy, and means for providing a report of the evicted page address and a counter value from a counter associated with the evicted page address if the counter value from the associated counter exceeds a minimum threshold count value.

Example 29 includes at least one non-transitory machine readable medium comprising a plurality of instructions that, in response to being executed on a computing device, cause the computing device to provide an array of hardware counters, and count accesses to one or more selected pages of a memory with the array of hardware counters.

Example 30 includes the at least one non-transitory machine readable medium of Example 29, comprising a plurality of further instructions that, in response to being executed on the computing device, cause the computing device to associate selected counters of the array of hardware counters with respective page addresses of the one or more selected pages.

Example 31 includes the at least one non-transitory machine readable medium of Example 30, comprising a plurality of further instructions that, in response to being executed on the computing device, cause the computing device to automatically provide a report of a page address and a counter value from a counter associated with the page address if the counter value from the associated counter reaches a threshold count value.

Example 32 includes the at least one non-transitory machine readable medium of any of Examples 29 to 31, comprising a plurality of further instructions that, in response to being executed on the computing device, cause the computing device to organize the array of hardware counters in a hardware counter set as a set-associate array of hardware counters.

Example 33 includes the at least one non-transitory machine readable medium of Example 32, comprising a plurality of further instructions that, in response to being executed on the computing device, cause the computing device to manage one or more configuration registers to store one or more of selected address range information, an increment value, an upper threshold count value, and a lower threshold count value.

Example 34 includes the at least one non-transitory machine readable medium of Example 33, comprising a plurality of further instructions that, in response to being executed on the computing device, cause the computing device to determine if a page address of an access to the memory hits an entry in the hardware counter set, and, if so determined, increment a counter associated with the page address by the increment value stored in the one or more configuration registers, and provide a report of the page address and a counter value from the counter associated with the page address if the counter value from the associated counter exceeds a maximum threshold value.

Example 35 includes the at least one non-transitory machine readable medium of any of Examples 33 to 34, comprising a plurality of further instructions that, in response to being executed on the computing device, cause the computing device to determine if a page address of an access to the memory misses in the hardware counter set; and, if so determined, allocate and initialize a free counter to the page address; and, if no free counters are available, evict a page address from the set-associative array based on an eviction policy, and provide a report of the evicted page address and a counter value from a counter associated with the evicted page address if the counter value from the associated counter exceeds a minimum threshold count value.

Techniques and architectures for hardware assisted memory access tracking are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1-21. (canceled)

22. An integrated circuit, comprising:
an array of hardware counters; and
circuitry communicatively coupled to the array of hardware counters, the circuitry to:
count accesses to one or more selected pages of a memory with the array of hardware counters.

23. The integrated circuit of claim 22, wherein the circuitry is further to:
associate selected counters of the array of hardware counters with respective page addresses of the one or more selected pages.

24. The integrated circuit of claim 23, wherein the circuitry is further to:
automatically provide a report of a page address and a counter value from a counter associated with the page address if the counter value from the associated counter reaches a threshold count value.

25. The integrated circuit of claim 22, wherein the array of hardware counters comprises:
a hardware counter set organized as a set-associate array of hardware counters.

26. The integrated circuit of claim 25, wherein the circuitry is further to:
manage one or more configuration registers to store one or more of selected address range information, an increment value, an upper threshold count value, and a lower threshold count value.

27. The integrated circuit of claim 26, wherein the circuitry is further to:
determine if a page address of an access to the memory hits an entry in the hardware counter set; and, if so determined,
increment a counter associated with the page address by the increment value stored in the one or more configuration registers; and
provide a report of the page address and a counter value from the counter associated with the page address if the counter value from the associated counter exceeds a maximum threshold value.

28. The integrated circuit of claim 26, wherein the circuitry is further to:
determine if a page address of an access to the memory misses in the hardware counter set; and, if so determined,
allocate and initialize a free counter to the page address; and, if no free counters are available,
evict a page address from the set-associative array based on an eviction policy; and
provide a report of the evicted page address and a counter value from a counter associated with the evicted page address if the counter value from the associated counter exceeds a minimum threshold count value.

29. A method, comprising:
providing an array of hardware counters; and
counting accesses to one or more selected pages of a memory with the array of hardware counters.

30. The method of claim 29, further comprising:
associating selected counters of the array of hardware counters with respective page addresses of the one or more selected pages.

31. The method of claim 30, further comprising:
automatically providing a report of a page address and a counter value from a counter associated with the page address if the counter value from the associated counter reaches a threshold count value.

32. The method of claim 29, further comprising:
organizing the array of hardware counters in a hardware counter set as a set-associate array of hardware counters.

33. The method of claim 32, further comprising:
managing one or more configuration registers to store one or more of selected address range information, an increment value, an upper threshold count value, and a lower threshold count value.

34. The method of claim 33, further comprising:
determining if a page address of an access to the memory hits an entry in the hardware counter set; and, if so determined,
incrementing a counter associated with the page address by the increment value stored in the one or more configuration registers; and
providing a report of the page address and a counter value from the counter associated with the page address if the counter value from the associated counter exceeds a maximum threshold value.

35. The method of claim 33, further comprising:
determining if a page address of an access to the memory misses in the hardware counter set; and, if so determined,
allocating and initializing a free counter to the page address; and, if no free counters are available,
evicting a page address from the set-associative array based on an eviction policy; and
providing a report of the evicted page address and a counter value from a counter associated with the evicted page address if the counter value from the associated counter exceeds a minimum threshold count value.

36. An apparatus, comprising:
a core;
memory communicatively coupled to the core; and
an array of hardware counters; and
circuitry communicatively coupled to the core, the memory, and the array of hardware counters, the circuitry to:
count accesses to one or more selected pages of the memory with the array of hardware counters.

37. The apparatus of claim 36, wherein the circuitry is further to:
associate selected counters of the array of hardware counters with respective page addresses of the one or more selected pages.

38. The apparatus of claim 37, wherein the circuitry is further to:
automatically provide a report of a page address and a counter value from a counter associated with the page address if the counter value from the associated counter reaches a threshold count value.

39. The apparatus of claim 35, wherein the array of hardware counters comprises:
a hardware counter set organized as a set-associate array of hardware counters.

40. The apparatus of claim 39, wherein the circuitry is further to:
manage one or more configuration registers to store one or more of selected address range information, an increment value, an upper threshold count value, and a lower threshold count value.

41. The apparatus of claim 40, wherein the circuitry is further to:
determine if a page address of an access to the memory hits an entry in the hardware counter set; and, if so determined,
increment a counter associated with the page address by the increment value stored in the one or more configuration registers; and
provide a report of the page address and a counter value from the counter associated with the page address if the counter value from the associated counter exceeds a maximum threshold value.
